(19) United States
(12) Patent Application Publication
(10) Pub. No.: US 2013/0097583 A1
(43) Pub. Date: Apr. 18, 2013

(54) Systems and Methods For Automating the Application of a Software Methodology

(71) Applicant: The University of Texas System, Austin, TX (US)

(72) Inventor: David C. Kung, Arlington, TX (US)

(73) Assignee: The University of Texas System, Austin, TX (US)

(21) Appl. No.: 13/629,593

(22) Filed: Sep. 27, 2012

Related U.S. Application Data
(60) Provisional application No. 61/539,751, filed on Sep. 27, 2011.

(51) Int. Cl. G06F 9/44

(52) U.S. Cl. CPC G06F 8/10
USPC 717/105

(57) ABSTRACT

Systems and methods are provided for an automation support tool for assisting/guiding a software engineer to follow a software methodology. The systems and methods assist the software engineer in identifying and graphically representing use cases, actors, systems, and subsystems; generate a domain model and a UML class diagram for visualizing the domain model; generating expanded use cases; generate an object interaction model; producing sequence diagrams; and create a design class diagram. From the design class diagram, the software engineer can produce high-quality computer programs. The system may include or connect to a diagram generator for automatically generating Unified Modeling Language (UML) class diagrams.

### CROSS REFERENCE TO RELATED APPLICATIONS

This application claims the benefit of the filing date of U.S. provisional patent application No. 61/539,751 entitled “Automated Method and Design For Object Oriented Programming”, which was filed on Sep. 27, 2011, by the same inventor of this application. That provisional application is hereby incorporated by reference as if fully set forth herein.

### FIELD OF THE INVENTION

The invention relates generally to systems and methods for creating computer programs in response to requirements of an entity and, more particularly, to systems and methods for automating part of all of the execution of a software creation methodology.

### BACKGROUND OF THE INVENTION

When creating a software product, requirements of the product (the desired features and functionality) are typically provided by the customer and/or extracted from the customer by a software programmer or software engineer (collectively referred to as a software engineer or engineer). The customer may be an individual, a business, a government agency or any other entity. It may be a third party or it may be an employer of the engineer. Once the general requirements are obtained from the customer, an analysis of the scope of the development should be determined and clearly stated. This is often called a scope document. From the scope document (or from the requirements), the software engineer can develop a software product that provides capabilities described in the requirements.

A software process, also known as a software development process, a software life cycle or a software development life-cycle (SDLC), provides structure for development of a software product by describing what tasks or activities need to take place while developing software. It does not describe how to perform the tasks or activities.

A software methodology is an organizational guide for performing the tasks or activities required for developing software. Thus, a software methodology is an implementation of a software process. Different methodologies may exist for the same process.

A software tool, software development tool or programming tool is a computer program or application that provides computer aided capabilities to facilitate the performance of a certain activity. Computer-aided software engineering (CASE) tools for assisting software methodologies have been sought after for many years, however, as a general rule they have not been very successful. Some conventional tools include Rational Rose Modeler® from IBM® and Visual Studio® from Microsoft®. These tools provide drawing support, but fail to guide and support the thinking process that a software engineer performs during the analysis and design process associated with software creation.

It would be advantageous to provide a CASE tool for assisting in the application of a methodology for the creation of a software product. It would also be advantageous to create a CASE tool that provides visualizations for the methodology. It would further be advantageous to provide systems and methods for automating the application of a methodology for creating software. It would still further be advantageous to provide a tool for automating a software creation methodology.

### BRIEF SUMMARY OF THE INVENTION

Many advantages of the invention will be determined and are attained by the invention, which in a broadest sense provides systems and methods for automating a methodology for creating software. Implementations of the invention may provide one or more of the features disclosed below.

Systems and methods are provided for an automation support tool for assisting/guiding a software engineer when following a methodology to create a software product/system. The systems and methods assist the software engineer in identifying and graphically representing use cases, actors, systems, and subsystems; generate a domain model and a UML class diagram for visualizing the domain model; generating expanded use cases; generate object interaction modeling; producing sequence diagrams; and create design class diagrams creation. The system may include or connect to a diagram generator for automatically generating Unified Modeling Language (UML) class diagrams.

Additional embodiments pertain to a corresponding method for guiding the software engineer and a corresponding hardware system for guiding the software engineer. Numerous other embodiments are also possible.

Aspects of the invention provide a system and method for converting user requirements into a software product which satisfies the requirements. Aspects of the invention include receiving as input to a software program at least one customer requirement, wherein the requirement includes at least a verb-noun phrase that indicates a task being accomplished for an actor who initiates the task, a noun or noun phrase that represents the actor and a noun or noun phrase that represents a system. Aspects of the invention also provide the software program parsing the requirement for the verb-noun phrase, noun or noun phrase representing the actor and noun or noun phrase representing the system, identifying the verb-noun phrase, noun or noun phrase representing the actor and noun or noun phrase representing the system as a use case. The use case is then converted into a graphical representation.

The invention will next be described in connection with certain illustrated embodiments and practices. However, it will be clear to those skilled in the art that various modifications, additions and subtractions can be made without departing from the spirit or scope of the claims.

### BRIEF DESCRIPTION OF THE DRAWINGS

For a better understanding of the invention, reference is made to the following description and examples, taken in conjunction with the accompanying drawings, in which like reference characters refer to like parts throughout, and in which:

FIG. 1 is a block diagram of a representative embodiment of a system in accordance with the invention;

FIG. 2 is a block diagram illustrating automation steps in according with aspects of the invention;

FIG. 3 is a sample requirement-use case traceability matrix in accordance with embodiments of the invention;

FIG. 4 illustrates examples of use case diagrams in accordance with embodiments of the invention illustrating actor inheritance;

FIG. 5 is a table describing notions and notations for use case diagrams;

FIGS. 6 illustrates representative screen shots in accordance with embodiments of the invention;

FIG. 7 is a table illustrating rules for converting from scenario tables to sequence diagrams in accordance with embodiments of the invention;

FIG. 8 illustrates rules for deciding function names, parameters and return variables in accordance with embodiments of the invention; and,

FIG. 9 illustrates a general overview of interaction between various features and functions of the system in accordance with embodiments of the invention.

The invention will next be described in connection with certain illustrated embodiments, examples and practices. However, it will be clear to those skilled in the art that various modifications, additions, and subtractions can be made without departing from the spirit or scope of the claims.

### DETAILED DESCRIPTION OF THE INVENTION

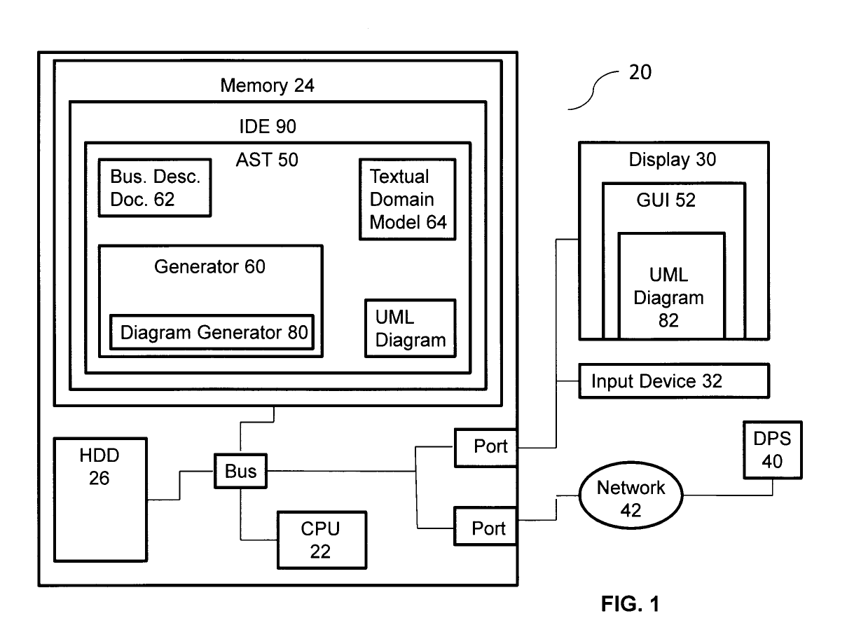

Referring to the drawings in detail wherein like reference numerals identify like elements throughout the various figures, there is illustrated in FIGS. 1-9 systems and methods for automating the execution of software creation methodologies according to the invention. The principles and operations of the invention may be better understood with reference to the drawings and the accompanying description.

The invention will be described in terms of unified modeling language (UML) and object oriented programming (OOP). Those skilled in the art will recognize, however, that these are design choices and the invention could be realized using other graphical modeling languages such as Business Process Modeling Notation (BPMN, and the XML form BPML), EXPRESS and EXPRESS-G (ISO 10303-11), Extended Enterprise Modeling Language (EEML), Fundamental Modeling Concepts (FMC), an IDEF modeling language such as IDEF0 for functional modeling, IDEF1X for information modeling, and IDEF5 for modeling ontologies, LePUS3 (an object-oriented visual Design Description Language and a formal specification language that is suitable primarily for modeling large object-oriented (Java, C++, C#) programs and design patterns), etc. and still fall within a scope of the invention. Those skilled in the art will also recognize that other software development methodologies may be employed such as Cap Gemini System Development Methodology (SDM), Structured systems analysis and design method (SSADM), Information Requirement Analysis/Soft systems methodology, Rapid application development (RAD), Dynamic systems development method (DSDM), Scrum, Team software process, Extreme programming etc. without departing from a scope of the invention.

Various approaches to software development have been established and employed over the years (e.g. waterfall, prototyping, incremental, spiral, rapid application development (RAD), extreme programming and others). Common to all, are the steps of obtaining the requirements of the customer and following a methodology for the project to create software that achieves the capabilities listed in the requirements. The invention provides a software tool that accepts the requirements as input and converts the requirements in accordance with a methodology into various models which can be employed by a software engineer to implement the project. In at least one embodiment, the invention is fully automated and in other embodiments, portions are controlled by the engineer. The invention may be employed to operate on all of the requirements together or incrementally on fewer than all of the requirements. Thus, it may be suitable for use with each of the various approaches.

While the ultimate goal of any system is to provide 100% accuracy, it is expected that a more reasonable expectation for the results of the invention are 80% accuracy. In other words, if 100% accuracy is defined as properly identifying all attributes, relationships, objects, actors, etc. that can be derived from the requirements (explicit and implied) then a goal of the invention is to properly identify approximately 80% of these. Such a result would probably be better than those achieved by an average novice software engineer. Depending on the project this may be sufficient or the results may be further refined by the engineer(s) prior to implementation/coding. While it is specified that a goal of the invention is to achieve 80% accuracy, the invention is not so limited. A system that provides less than or more than 80% accuracy could still fall within a scope of the invention.

FIG. 1 is a block diagram depicting a suitable computing environment/system in which aspects of the present invention may be implemented. The system 20 may include a central processing unit (CPU) 22, volatile data storage devices such as random access memory (RAM) 24, and non-volatile data storage devices such as read-only memory (ROM), a hard disk drive (HDD) 26, and other devices or media, such as floppy disks, optical storage, tapes, flash memory, memory sticks, digital video disks, etc. System 20 may also include various input/output (I/O) ports, a display 30, one or more input devices 32 (such as a keyboard and a pointing device), etc. In addition, system 20 may communicate with one or more remote hardware and/or software systems 40 via a network 42, such as a local area network (LAN), a wide area network (WAN), an intranet, the Internet, etc.

A system according to the present invention begins with a requirements specification. The requirements are employed for use case modeling (UCM), domain modeling (DM), object interaction modeling (OIM) and design case diagram(s)(DCD). The design case diagrams are then employed to implement/code the desired software product.

For purposes of this disclosure, the terms “program” or “software product” cover a broad range of software components and constructs, including applications, drivers, processes, routines, methods, modules, and subprograms. The terms may be used to refer to a complete compilation unit (i.e., a set of instructions that can be compiled independently), a collection of compilation units, or a portion of a compilation unit. Thus, the terms may be used to refer to any collection of instructions which, when executed by a processing system, perform a desired operation or operations. Programs may generate user interfaces for use by software engineers or other human users. Any suitable techniques may be used to interact with such user interfaces. For instance, a pointing device may be used to move a pointer to desired locations and conventional click-and-drag techniques may be used to highlight or select particular phrases or objects, to interact with pop-up menus, etc.

Object-oriented programming refers to a programming framework or paradigm that uses “objects” to design computer programs and applications. An object may relate to a particular real-world concept, such as a product, a product manufacturer, a customer, etc. An object may be implemented as a variable that comprises both data and associated routines or “methods,” with the variable nevertheless treated as a discrete entity. An object-oriented application may be created to provide data processing services for a particular field of use or domain.

Use Case Modeling: A use case is a process that begins with an actor, ends with an actor and results in a task being accomplished for the actor. An actor is a role played by and on behalf of an entity (or entities) external to the system but which interacts with the system. For example, suppose the desired software is a library information system (LIS) and one of the requirements is that “the LIS shall allow a patron to checkout books”. The use case in this example is “checkout books”, the actor is the “patron” and the task is “checking out books”. While an actor will typically be a human user, the invention is not so limited. In some cases, a software system may be embedded in a larger system, which may be a hardware-software system or include other subsystems. In these cases, the system under development may receive requests from and deliver results to hardware devices or other subsystems of the total system. Thus the actor in these scenarios may be hardware or software as opposed to a human actor. Additionally, an actor may play different roles in the same use case. For example, in the LIS example, it is possible that a librarian both checks out books and handles the checkout transaction. Thus, the librarian would be both the librarian and the patron.

Use cases are derived from requirements by: (1) identifying use cases and subsystems, (2) defining use case scopes, (3) visualizing, (4) reviewing and allocating the use cases to iterations.

1—Identifying use cases is performed using three rules: (i) parse a requirement for verb-noun phrases that meet the definition of a use case; (ii) parse the requirement for noun phrases that meet the definition of actors, and noun phrases representing subsystems that contain the use cases; and, (iii) rearrange the use cases among the subsystems to improve subsystem cohesion. Using the results from these three rules, the system produces a requirement-use case traceability matrix to show which use cases realize which requirements.

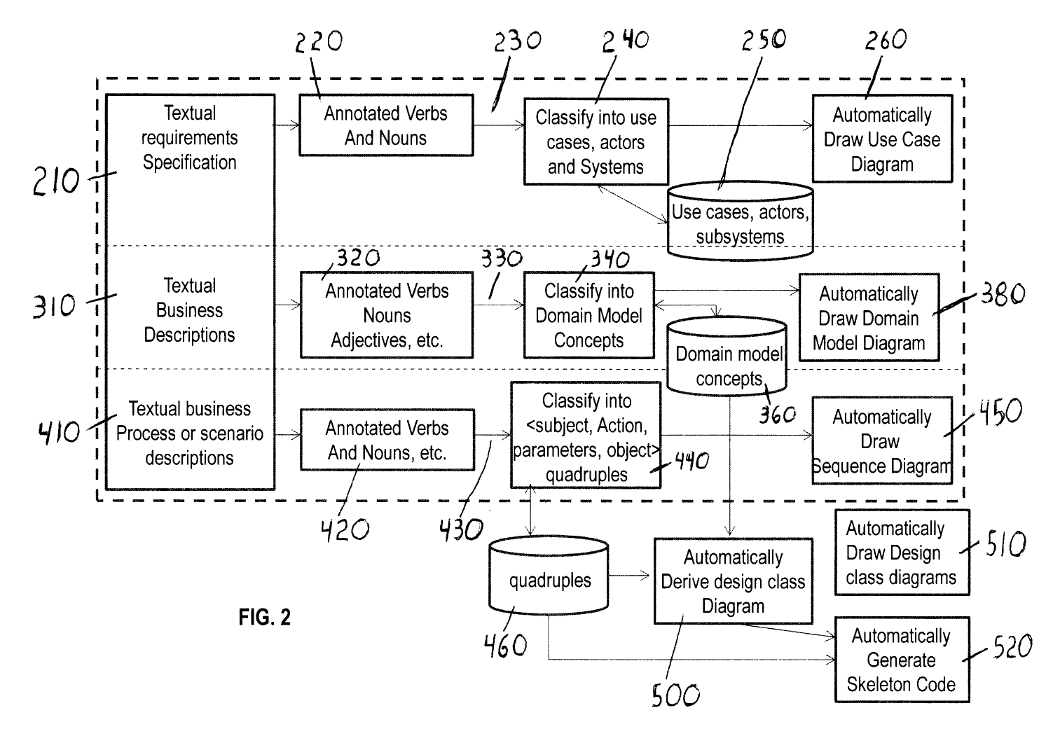

FIG. 2 illustrates how, among other things, embodiments of the invention derive use cases from the requirements. As illustrated, the system receives requirement descriptions 210. The text from these descriptions is parsed and the verbs and nouns are annotated 220 using a conventional part of speech tagger. The results of the tagger are converted into a result that employs extended markup language (XML) tags. For example a noun such as “teacher” is annotated as “<N teacher>”, a verb such as “teach” is annotated as “<V teach>,” etc. The annotated texts 230 are then input to the classifiers 240, which apply the above disclosed classification rules of the methodology to classify the annotated texts into use case model concepts (also referred to as “abstract” use cases). The classification processes save the use case model concepts in one or more databases. Embodiments of the invention may provide the engineer with the ability to correct and/or supplement this list of use case model concepts, although such a feature is not a requirement of the invention. For instance, the engineer could add use case model concepts that could only be inferred from the requirements.

Preferably at the same time as the use cases are identified, but not required to be, the actor(s) and the system(s) or subsystem(s) are identified. To identify the actors, the system looks for nouns and noun phrases that represent roles played by external entities that initiate the use case, or for which the task is performed. To identify the systems or subsystems that contain the use cases, the system identifies nouns and noun phrases that represent system(s), subsystem(s), or aspects of the business to which the use cases belong. The requirements may not always show explicitly, exactly, or literally a verb-noun phrase. For example, “startup system” and “shutdown system” are often abbreviated to “startup” and “shutdown” in requirement specification documents. Thus, the identified verbs and nouns may be compared against a variety of lists, which may be static or which may grow over time. In some embodiments, the engineer(s) may infer the processes from the requirements first and then derive the use cases.

When an entire system is developed from scratch, the requirements often refer to the system as a whole and mention no other subsystem(s). When this happens, the use cases identified previously will be assigned to the system. In this situation the use cases should be rearranged/partitioned according to their functionality to form subsystems based on the partitions. The goal is to form subsystems that exhibit high functional cohesion, that is, the use cases of each subsystem should exhibit core functionality and be limited to small numbers of use cases so that each subsystem is easy to design, implement, test and maintain. To accomplish these goals, the use cases may be rearranged among the subsystems, a subsystem may be decomposed to reduce complexity, and some of the subsystems may be merged.

The use cases are grouped according to the following observations: role based partitions—where use cases for a common actor tend to exhibit role-specific functionality; communicational partitions—where use cases that process a common object tend to perform object-specific tasks (called communicational partition because the use cases communicate via the common object they process); type-based partitions—where the object that modifies the noun of the use case may be used to partition the use cases; and, inheritance relationship between actors may be employed to rearrange the use cases among subsystems (e.g. to reduce the number of use cases of a subsystem, use cases of an actor subclass can be separated from use cases of the actor superclass to form a subsystem of their own; and use cases of an actor subclass can be merged with use cases of an actor superclass to reduce the number of subsystems if desired).

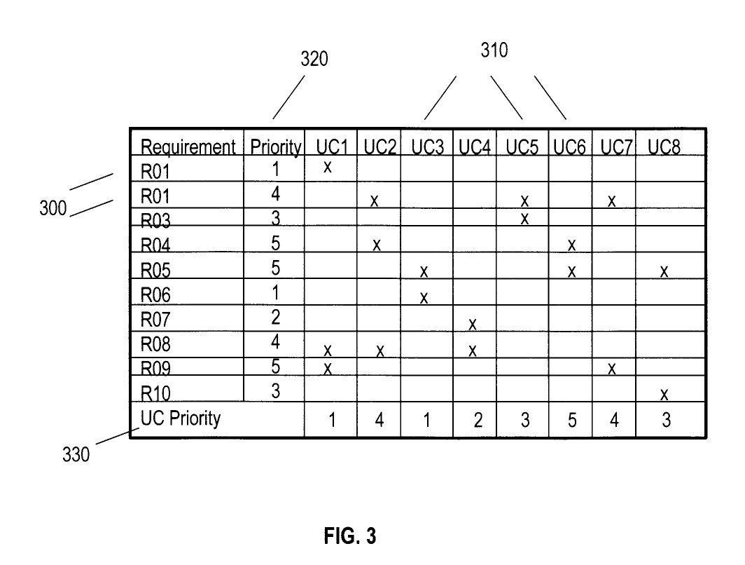

Traceability Matrix: The fact that a use case is derived from a given requirement is entered into a Requirement-Use Case Traceability Matrix (RUTM). FIG. 3 shows a dummy RUTM, where the rows 300 represent requirements and the columns 310 represent use cases. The second column 320 shows the priorities of the requirements with 1 being the highest and 5 the lowest (merely a design choice). The priorities may have been obtained during the requirements phase. If a use case is derived from a requirement, then the corresponding requirement-use case is checked. The UC Priority row 330 shows the priorities of use cases. It is the highest priority of the associated requirements. The use case priorities may be useful for planning the iterations. For example, use cases with the highest priority may be developed and deployed first.

The RUTM provides various benefits. It can be used to identify use cases that realize a given requirement. It can also be used to identify requirements that are realized by a given use case. This bi-directional traceability ensures that each requirement will be delivered by one or more use cases (i.e., there are no blank rows) and it lets the engineer know if any use cases are missing (if no use case satisfies a particular requirement). It ensures that all of the use cases are required (i.e., there are no blank columns) and it enables high-priority use cases to be developed and deployed as early as possible.

2—Specifying Use Case Scopes: A high-level use case specifies when and where a use case begins and when it ends. In other words, it specifies the use case scope. This may also be referred to as the stopping rule as it provides a guideline for the engineer where to stop adding features and functionality to the program. Use case scopes are specified in two declarative sentences: (i) “this use case begins with” (TUCBW) followed by the actor performing the actor action and where the actor action takes place and (ii) “this use case ends with” (TUCEW)” followed by the actor explicitly or implicitly acknowledging that the use case accomplishes the intended task (for the actor). This may be differentiated from an abstract use case which is identified by the verb-noun phrases.

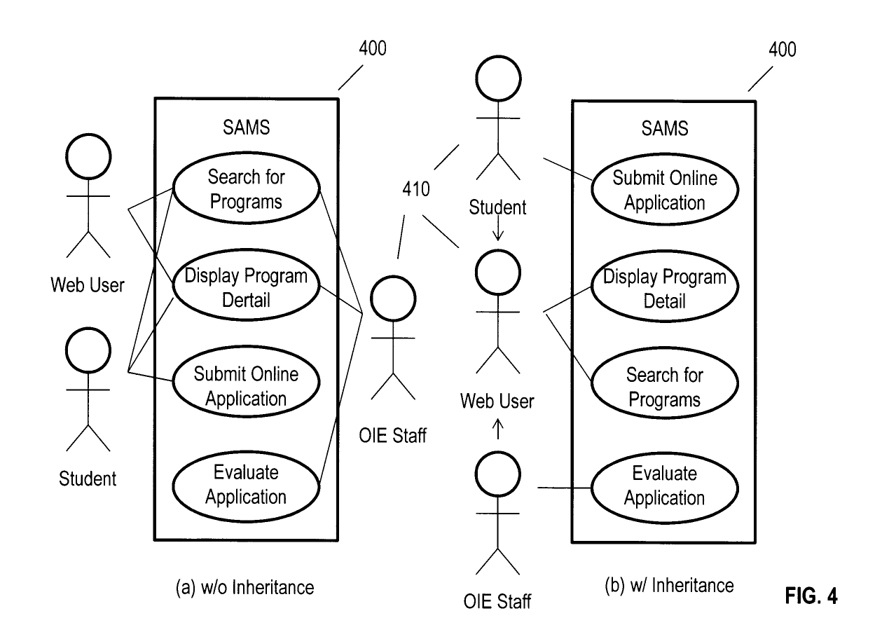

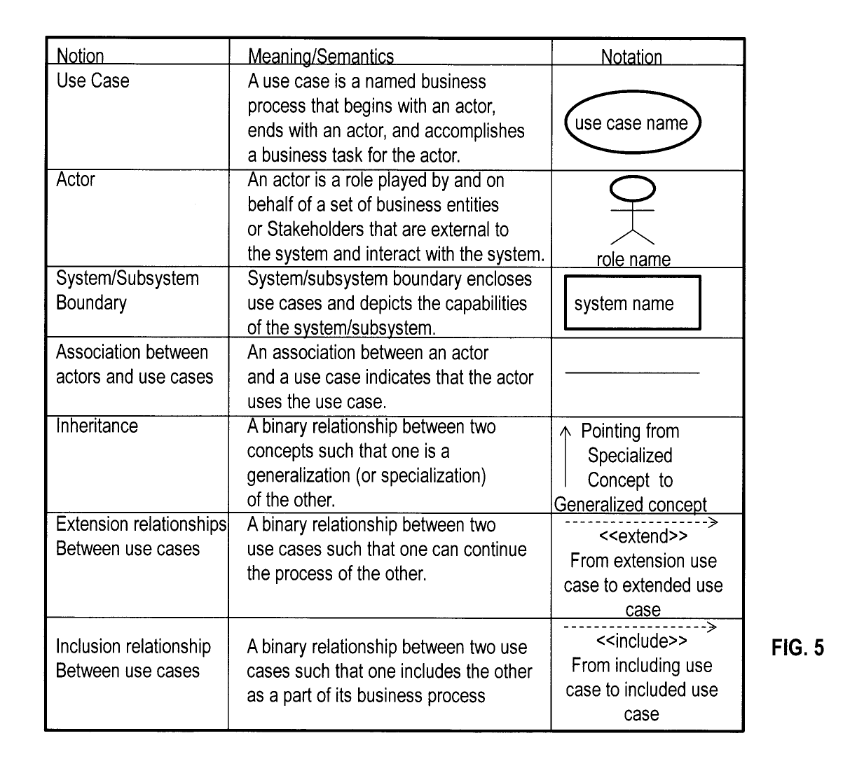

3—Visualizing Use Case Contexts: software development for complex systems is easier to organize using visualization as opposed to textual descriptions of use cases, actors and subsystems. Unified Modeling Language (UML) use case diagraming fulfills this need, although those skilled in the art will recognize that other visualization methods may be employed). As illustrated in FIG. 4 a use case diagram is a UML behavioral diagram that depicts use cases of a system or subsystem, actors that use the use cases, the system or subsystem boundary 400, inheritance relationships between actors, and relationships between use cases. Part of what makes the diagram useful is the various notations which represent the various notions. By way of example, FIG. 5 illustrates the relationship between various notations and notions.

4—Reviewing Use Case Specifications: In this step, the use cases and use case diagrams are reviewed using the following checklist.

### Abstract Use Cases

1. Does each use case name consists of a verb-noun phrase and communicate what the use case accomplishes for the actor?
2. Does each use case represent a business process?
3. Can any of the use cases be split into two or more use cases?
4. Can any of the use cases be merged?

### Requirement-Use Case Tractability Matrix

1. Is there a requirement-use case tractability matrix?
2. Is every requirement listed in the tractability matrix?
3. Is there a blank row or blank column in the requirement-use case tractability matrix?
4. Are the use cases listed for each requirement necessary for the requirements?
5. Are the use cases listed for each requirement sufficient for the requirement?

### High Level Use Cases

1. Is there a high-level use case specification for each use case identified?
2. Does the TUCBW clause of each high-level use case clearly specify when and where the use case begins?
3. Does the TUCEB clause of each high-level use case clearly specify when the use case ends and ends with what the use case accomplishes for the actor?
4. Does each high-level use case correctly specify the scope of the business process?

### Use Case Diagram

1. Does each use case diagram show the subsystem boundary?
2. Is the subsystem name appropriate for communicating the functionality of the subsystem?
3. Is there a one-to-one correspondence between the use cases in the use case diagrams and the requirement-use case traceability matrix?
4. Is there any use case diagram with an excessive number of use cases?
5. Is there any use case diagram containing only one use case without a good reason?
6. Is there any use case diagram containing a use case or actor that is not connected to a use case or actor?
7. Is there any actor that does not have a role name?
8. Is each use case linked to the appropriate actor?
9. Is each use case assigned to the appropriate subsystem?

Allocating the Use Cases to Iterations: Once the use cases are identified and visualized, a schedule is created for developing and deploying the use cases. This is called planning the iterations with use cases. First, the effort required to develop and deploy each use case is estimated. Next, the dependencies between the use cases are identified so that they will be deployed according to their dependencies. For example, “checkout book” is deployed prior to “return book.” Finally, an iteration schedule is produced. The generation of the schedule should take into account the following factors, in descending order of importance:
1. The priorities of the use cases. High-priority use cases should be developed and deployed as early as possible to satisfy the customer's needs and priorities.
2. The dependencies among the use cases. If use case B depends on use case A, then B should not be deployed before A because the users won't be able to use B without A.
3. The team's ability to develop and deploy the use cases. The effort required by the use cases allocated to an iteration should not exceed the ability of the team to develop and deploy them.

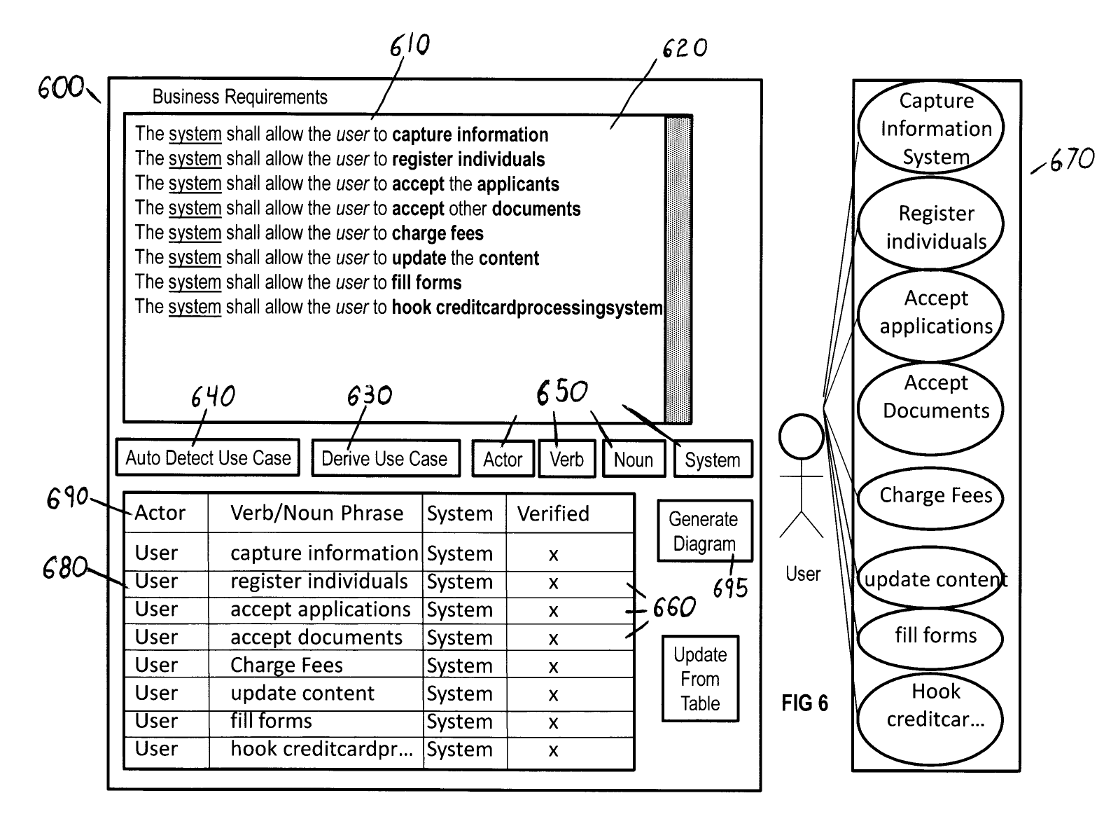

FIG. 6 illustrates a representative embodiment of a portion of the invention related to use cases. Those skilled in the art will recognize that the layout of the screen 600 and the labels provided for buttons/functions illustrated in FIG. 6 are for illustration purposes only and other layouts may be employed without departing from a scope of the invention. One or more requirements 610 are entered into the system. This can be done through keyboarding, importing a file or through any other conventional method. The requirements are displayed in the top window pane 620 of the user interface (UI) 600. The software engineer may be provided the option to manually 630 identify use cases, actors and systems from the requirements or have the system perform this function 640. In the manual scenario, the engineer highlights words from the requirement 610 and selects the button representing its identity 650 (verb-noun phrase, actor, system). When the engineer finishes identifying a use case, some use cases or all of the use cases, the system may request confirmation 660 that this use case is correct. This confirmation may be as simple as selecting a radio button 660 verifying that the use case is correct or as detailed as requiring the engineer to answer questions about the use case (e.g. does it begin with an actor, end with and actor, complete a task for the actor, etc.). Alternatively, the user may select the auto-detect button 640 in which case the system performs the task of identifying use cases from the requirements 610. Once the system has identified a use case, some use cases, or all of the use cases it preferably requires the engineer to verify that they are correct. Those skilled in the art will recognize that this step is not required. The system optionally may also provide the engineer with the option of adding use cases to the list of use cases identified by the system. Each of the identified use cases is listed in the lower window pane 680 with its parts identified under the appropriate heading 690.

Once use cases have been identified, the engineer may select the Generate Diagram button 695 and the system computes the graph layout and generates the use case diagram 670 automatically. This can be displayed in a new window, printed in hard copy, saved to a file and/or displayed on screen. The system may work independently of any other software design tools or it may incorporate other conventional software tools (e.g. software tools exist for generating use case diagrams).

Domain modeling. Domain modeling is the subject of my co-pending U.S. patent application Ser. No. 12/976,114 filed Dec. 22, 2010 entitled “Automation Support For Domain Modeling” which is incorporated by reference as is fully set forth herein. As such the disclosure of domain modeling will not be repeated.

Actor-system interaction modeling. Expanded use cases are produced in a conventional manner. They specify how the actor will interact with the system to carry out the use cases. A two-column table is created. In the left column is the actor's input and in the right column is the system response.

Object interaction modeling (OIM). An engineer may use the system to specify the interaction among the software objects to carry out background processing of the use cases. OIM may be realized in five steps: (1) collecting information about the existing customer processes; (2) describing use case scenarios; (3) constructing scenario tables if necessary; (4) visualizing object interaction behaviors using UML sequence diagrams; and (5) performing inspection and review. As illustrated in the lowest row of FIG. 2, OIM may be automated in a similar fashion as that described with regard to deriving use cases, based on these rules and the following descriptions.

OIM is a process to (i) help understand how objects interact in the existing customer processes, (ii) help identify problems and limitations of the existing customer processes, and/or (iii) design and specify how objects interact in the proposed software system to carry out the use cases. The first two objectives address the modeling and analysis and the last objective addresses designing object interact behaviors to solve design problems such as design of object interaction behavior (the design of sequences of messages between the objects or how objects collaborate to improve the existing business processes), object interfacing (the design of the signatures and return types of the functions of the objects) and design for better (the application of design patterns to produce a design that meets specific needs, and exhibits desired properties including low coupling, high cohesion, proper assignment of responsibilities to objects, and easy adaption to changes in requirements and operating environment). Analysis is application-problem oriented while design is software-solution oriented. This means that during the analysis phase, the development team focuses more on understanding the application domain, identifying problems in the existing application, and proposing, possibly innovative, solutions (to the application or customer problems). During the design phase, the development team focuses more on developing and specifying appropriate software architecture and its elements to realize the proposed solution to the extent that the proposed solution can be readily implemented by computer programs. The software solution should also take into consideration a number of software design principles, e.g., high cohesion, low-coupling, separation of concerns, and design for change. During the analysis phase, the development team constructs models about the application domain to help understand the application. During the design phase, models of the software system are constructed. For example, during the analysis phase a domain model and possibly sequence diagrams for existing business processes are constructed to help understand the existing application. During the design phase, sequence diagrams are constructed to specify how objects interact to carry out a use case. A design class diagram is derived from the design sequence diagrams to show the classes, their behaviors and attributes, and the relationships between the classes in the software system.

Step 1—Collecting Information About the Existing Business Processes. To acquire sufficient knowledge of the customer processes, the development team may work with the customer and users to collect information about the business processes. The information gathered during the requirements analysis phase may be reused and additional information may be gathered if needed. The following is a non-exhaustive list of items on which to focus during the information collection process:
1. What is the current business situation and how does it operate?
2. What is the business/customer need for which the computerized system is being built?
3. What are the business goals, or product goals?
4. What are the existing business processes to accomplish the goals?
   a. What is the functionality of each of these processes?
5. What are the input and output of each of the existing business processes?
6. How do existing processes work?
7. How do existing processes relate and interact with each other?
8. What are the improvements or enhancements expected by the customer and users?Also, by studying similar projects, the team/system may learn from experiences of other projects including the functionality of similar systems, how these systems are designed and implemented. Using questionnaires may be useful for collecting information from the users and/or customer. Also, interviews and reviewing operating procedures, forms and reports may provide valuable insight.

Step 2—Describing use case scenarios. Scenarios are widely used to describe how objects interact with each other to accomplish a task. The scenarios are then converted into UML sequence diagrams. If the business process being modeled is complex or involves many steps, then the sequence diagram appears to be complex and lengthy. As a consequence, it may be difficult to understand. To avoid this problem, the invention uses sequence diagrams to model the nontrivial steps of an expanded use case.

Identifying Nontrivial Steps. An expanded use case is a two column table that describes how an actor interacts with the system to carry out a business process. More specifically, the left column of the expanded use case specifies the actor requests while the right column specifies the system responses. Certain actor requests require the system to perform background processing. That is, it requires software objects to interact and collaborate with each other to fulfill the request. Such an actor request is a nontrivial actor request, or nontrivial request. The following tips are useful for identifying nontrivial steps:
1. If the system response simply displays a menu, or input dialog, then the step is trivial.
2. If the system response is different for different instances of the actor, then the step is nontrivial.

The steps for writing scenarios for nontrivial steps are as follows:
1. Identify nontrivial steps in the right column of the expanded use case.
2. Mark the right-column step with an asterisk (“*”). A scenario beginning with the corresponding left-column step needs to be specified. The team may decide not to perform object interaction modeling for a nontrivial step if the team knows well how to implement the step.
3. Specify a scenario for each nontrivial step beginning with the left-column step. This step produces a partial use case scenario. The complete use case scenario consists of all of the steps specified in the expanded use case with the nontrivial steps replaced by the partial use case scenarios.
4. Number the scenario statements using legal decimal numbers like 4.1, 4.2, 4.2.1, to highlight sequencing and nesting.

Step 3—Constructing Scenario Tables. Deriving sequence diagrams from scenarios is not an easy task because the relationship between the two is not always obvious. A solution to this problem uses an intermediate representation. It can be derived from a scenario and converted to a sequence diagram. This representation is called a scenario table. A scenario table has five columns. The first column denotes the object interaction statement number. The other columns correspond to the subject, subject action, data or objects required by the subject action, and the object acted upon, respectively. In other words, a scenario table is a tabular representation of a scenario. It separates the components of the scenario sentences into the columns of the scenario table. This tabular representation facilitates the conversion of the scenario into a sequence diagram. Another reason to construct the scenario table is that it facilitates automatic generation of sequence diagrams because the mapping from the table to a sequence diagram can be carried out mechanically. Converting a scenario into a scenario table involves identifying and highlighting the subject, subject action, data or objects required by the subject action, and object acted upon. These are then entered into the scenario table row by row and column by column.

Scenario statements involve an object which requests another object to perform an action. The latter in turn may request other objects to perform other actions. This discussion suggests that scenario writing for a nontrivial step should make the following decisions:
1. Identify the tasks to be carried out to fulfill the actor request.
2. Determine the desired order to carry out the tasks.
3. For each of the tasks, determine the object to carry out the task.
4. For each of the tasks, determine the object to issue the request to perform the task. The process is an iterative process. It begins with the nontrivial step and decomposes it into a number of tasks. Each of these tasks is decomposed until no refinement is needed. Next the tasks are arranged in the desired order to execute them. To determine an object to perform a task, look it up in the following places: the objects that participate in the current scenario, the design class diagram, the domain model. If the object is not found in these places, then look up the object in other places such as code and related business documents. As a rule of thumb, the object to issue the request is either the subject or the object on the previous row of the table. Thus:
1. If the task on the current row is a subtask of the task on the previous row, then the requesting object is the object on the previous row.
2. If the task on the current row is not a subtask of the task on the previous row, then the requesting object is the subject on one of the previous rows. In most cases, the requesting object is the subject of the previous row.
3. For the first task, the requesting object is the GUI object that receives the nontrivial actor request. This GUI object is usually named after the name of the use case.
Two other activities are performed to complete the scenario. First, for each task that returns a result, insert a row to return the result from the object acted upon to the requesting object. Second, insert conditional and loop statements at appropriate places if necessary. Finally, statement numbers are entered in the first column.

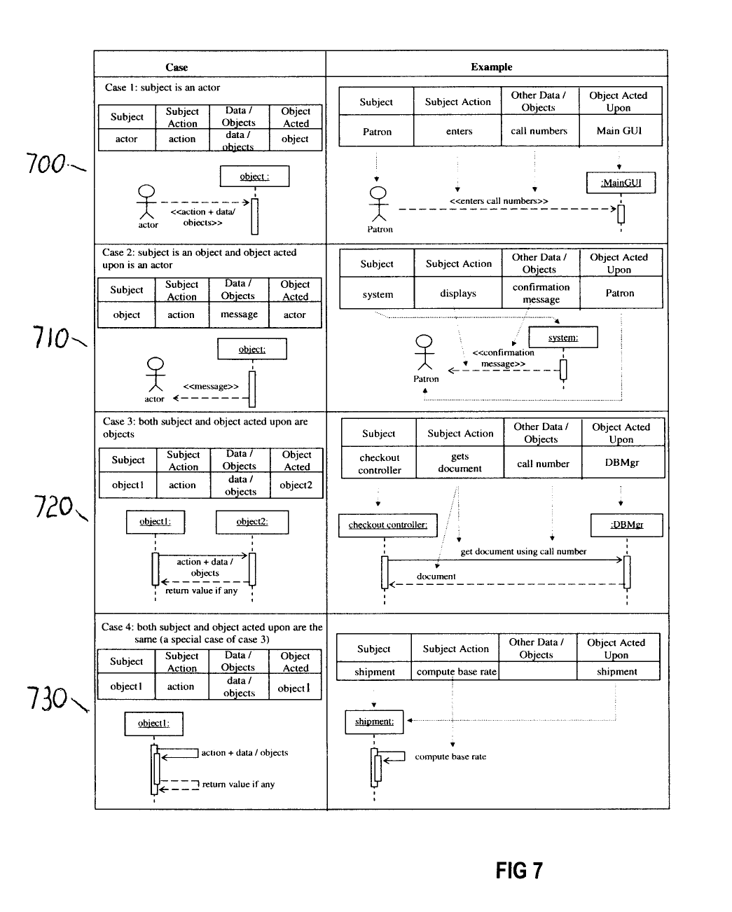

Step 4—Deriving Sequence Diagrams from Scenario Tables. It is desirable to visualize the scenarios of object interaction with UML sequence diagrams. This involves the following steps:
1. Converting scenario tables to sequence diagrams. In this step, an informal sequence diagram is derived from each scenario table. The conversion rules displayed in FIG. 7 are applied to accomplish this task.
2. Deciding on instance names and types. In this step, the names and types of the object instances that send and receive messages are defined.
3. Deciding on object interfacing. In this step, the function names, parameters, and return types are determined.
Converting the scenario tables to sequence diagrams is guided by the conversion rules described in FIG. 7. In particular, each row of the scenario table is translated into a message that is passed between two objects, or between an actor and an object. There are four different cases, which are processed differently:
   1. The subject is an actor. In this case, the object acted upon can only be an object. This case represents an actor issuing a request to the software system. The request is entered in some way through an input device. This converts to a stereotype message from the actor to the software system. The stereotype message is a dashed arrow line with its label enclosed in a pair of double angle parentheses, as shown by the first case 700 in FIG. 7.
   2. The subject is an object and the object acted upon is an actor. This case represents the system delivering the system response to the actor. Most of the time this is accomplished through displaying a menu, a dialog, or information on the screen. This converts to a stereotype message from the system to the actor, as illustrated by the second case 710 in FIG. 7.
   3. The subject is an object and the object acted upon is an object. This case represents a function call from one object to another object. It is widely referred to as message passing. The call may involve a returned result from the object being called to the object that issues the call. This case converts to a solid arrow line, labeled by indicative texts, from the caller to the callee. The returned result, if any, is modeled by a dashed arrow line, labeled by the returned result, from the callee back to the caller. The third case 720 in FIG. 7 illustrates how to convert this case.
   4. The subject and the object acted upon are the same object. This case represents a call from a function of an object to another function of the same object. It is modeled by a solid arrow line from the object back to itself, as shown in the last case 730 of FIG. 7.

Deciding on Instance Names and Instance Types. Recall that when a scenario table is converted into a sequence diagram, the instance names and instance types are not specified. This step specifies the instance names and types by applying the following rules:
1. If an instance is used as a parameter or return value in the sequence diagram, then give the instance an instance name so that the instance name can be used to refer to that instance.
2. If an instance is not an instance of a class, then give the instance an instance name and make the instance a stereotyped instance. Giving the instance a class name could cause confusion.
3. When deciding on the class for an instance, look it up first in the current sequence diagram, then the design class diagram, and finally in the domain model. If the needed class is not found in any of these diagrams, then introduce a new class and give it a meaningful class name.
4. When deciding on the class for the elements of a collection, two different cases should be considered:
   a. If the elements of the collection are instances of only one class, then that class is the class for the elements of the collection.
   b. If the elements of the collection are instances of subclasses of a superclass, then the superclass is used as the class for the elements of the collection.

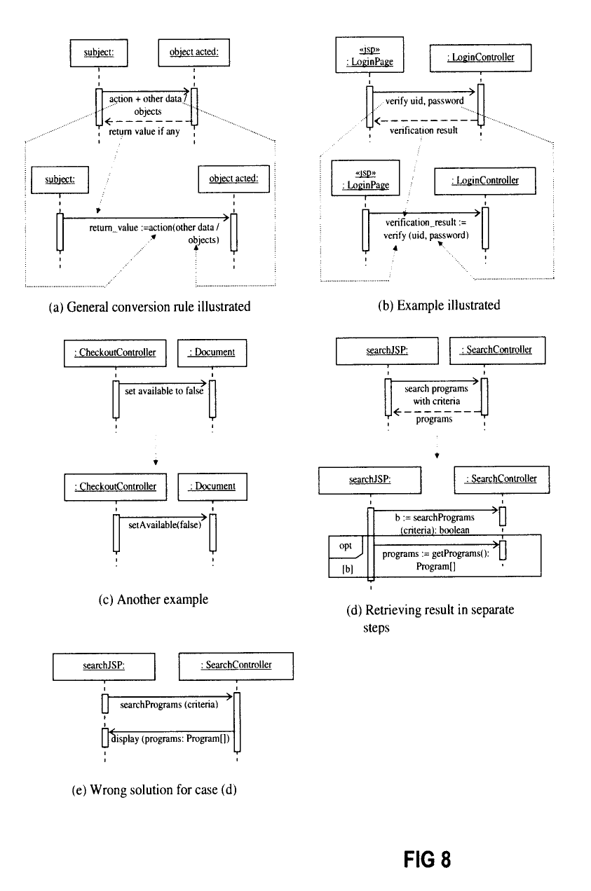

Deciding on Object Interfacing. This section describes how to convert informally specified messages into formally specified messages. This, in effect, converts informal or analysis sequence diagrams to design sequence diagrams. Most times only messages that are passed between two software objects need to be considered. The exception to this is when the actor is a software subsystem/component that requires a formally defined interface. An informally specified message is translated into a formally specified message as follows: The subject action is converted into a function name, and the data or objects required by the subject action are converted into parameters. If the object acted upon returns a result, then the result is saved in a variable, which is introduced for this purpose. If more than one piece of information is returned, then additional calls to appropriate get functions are introduced to retrieve the results. In most cases, the conversions are straightforward. FIG. 8 shows the conversion rules and examples.

FIG. 8(a) shows the general rule and FIG. 8(b) an example.

FIG. 8(c) illustrates a case that does not have a return result. FIG. 8(d) depicts a situation in which the search results are retrieved in a separate step if the call to search(criteria) returns true.

FIG. 8(e) is sometimes seen as an alternative solution to FIG. 8(d). That is, instead of having searchJSP (Java Server Page) to call getPrograms( ) of SearchController, a call from SearchController to searchJSP is used. However, this solution is not preferred. First, it introduces a cyclic coupling between SearchController and searchJSP. This tight coupling makes software reuse more difficult. Any reuse of SearchController brings along searchJSP and vice versa, regardless if the other one is needed or not. Second, this solution changes the client-server relationship, that is, SearchController is no longer the server and searchJSP is no longer the client.

Deciding on parameter types and return types is an application dependent issue as well as a software design consideration. This means that domain knowledge is required and may be found in the domain model. It is a design issue because there are different ways to pass a certain piece of information or data between two objects. In this regard, it is desirable to accomplish a low-coupling as described by the following guidelines:
1. Use data coupling whenever possible and appropriate. Data coupling means that a single data value is passed as a parameter or return value from one function to another. The data value is only used in a computation to produce some result, not in selecting a path or control flow in a program.
2. Prefer object coupling over stamp coupling. Make sure that the update functions implement the necessary integrity checks. Stamp coupling means that a data structure is passed as a parameter or return value from one function to another. Similarly, object coupling means that an object is passed between two functions. Object coupling is preferred because the accessor functions, such as getX( ) and setX( ), could implement integrity checks to ensure that the data structure is used correctly.
3. If several attributes of an object are passed as parameters to a function call, then use object coupling instead.
4. Avoid control coupling, common coupling, and external coupling. Control coupling means that two functions are coupled with a control variable, which determines the program path or control flow at run time. Control coupling means that the behavior of one object is controlled by another object. The run time behavior is very difficult to predict, test, and debug. Therefore, control coupling should be avoided if possible. Common coupling means that functions communicate through a global data area or a global variable. Concurrent updates to such variables may produce strange behavior. In object-oriented programming, the use of a public static data member constitutes a common coupling because that data member can be accessed and updated by all objects. External coupling means that functions communicate via the memory space of an external device. This type of coupling should be avoided if possible because the external memory space could be modified by external programs, resulting in unpredictable behavior.

Step 5—Object Interaction Modeling Review Checklist.
1. Check that the scenarios and sequence diagrams correctly and adequately describe the improved business processes.
2. Check that all messages of a design sequence diagram are formally specified and there is no use of dashed arrow lines to return a result to an object.
3. Check that all required parameters and return values are present and the parameters are defined before used in a function call.
4. Check that no object is retrieved from the database, updated but not saved back to the database.
5. Check that the function names properly communicate the functionality.
6. Check that each sequence diagram satisfies all of the following conditions:
   a. The sequence diagram is syntactically correct.
   b. The sequence diagram correctly describes the algorithm, or scenario.

Deriving Design Class Diagrams (DCD). A design class diagram is a UML class diagram, derived from the behavioral models and the domain model. It is a design blueprint to facilitate the subsequent implementation, testing and integration activities. DCDs are constructed to help develop, communicate and validate design ideas, which are otherwise distributed among the engineers. Deriving DCD may be automated in a similar fashion as that described with regard to deriving use cases, based on the following rules and descriptions.

Steps for Deriving a Design Class Diagram. The steps for deriving the DCD from the design sequence diagrams are: (1) identifying classes, (2) identifying methods, (3) identifying attributes, (4) identifying relationships, and (5) reviewing the DCD.

Step 1—Identifying classes. Classes to be included in the DCD are identified from the design sequence diagrams. The classes of objects are identified from the following three places in a design sequence diagram:
1. Identify classes of objects that send or receive messages. The objects that send or receive messages are represented by rectangles with underlined object name and type separated by a colon. These rectangles are placed at the top of each design sequence diagram. Therefore, classes of objects that send or receive messages are identified by such rectangles in the design sequence diagrams.
2. Identify classes of objects that are passed as parameters. Such classes are identified from the parameters passed in the messages sent or received by the objects in the design sequence diagrams.
3. Identify classes that serve as return types. Classes that are return types are identified from the return types of the messages between the objects in the design sequence diagrams.
The above rules should be applied to all of the design sequence diagrams produced in the current iteration, not to just one of the sequence diagrams produced. A class may be identified by more than one rule, therefore, once a class is identified, it should not be identified again. Since the DCD serves as the design blueprint for the system, a single DCD should be sufficient for all the behavioral models and all iterations.

Step 2—Identifying Messages. In a design sequence diagram, a message x:=m( . . . ):X that is sent from an object A to another object B indicates that A calls the m( . . . ):X function of B and saves the result in the variable x of type X. Therefore, the methods of a class are identified from all such messages from all the design sequence diagrams produced. More specifically, the methods for a class B are identified from the horizontal arrow lines that go to the method executions of an object of B in any of the design sequence diagrams. From the labels of the arrow lines, the methods of B are identified.

Step 3—Identifying Attributes. Attributes are identified from the messages in the design sequence diagrams using the following rules:
1. Identify attributes from methods that retrieve objects. A message of the form getX(a:T):X, where X is a class and T is a scalar type, suggests that a is an attribute of X and the type of a is T. However, whether a is an attribute of X or not should be verified using the domain model or domain knowledge.
2. Identify attributes from the ordinary get and set methods. In object-oriented programming, the ordinary get and set methods are used to retrieve and update attributes of an object. This observation suggests that attributes of a class can be identified from messages such as t:=getX( )T and setX(x:T) that are sent to a class A, where X and x are a noun or intended to be a noun and T is a scalar type. These messages suggest that the noun X or x is an attribute of A and the type of the attribute is T.
3. Identify attributes from isX( ):boolean and setX(b:boolean) methods, where X is an adjective. Recall from domain modeling, an adjective could be an attribute or attribute value. Methods that are named isX( ):boolean or setX(b: boolean), where X is an adjective, often suggest that isX is a boolean attribute of the object that receives the message.
4. Identify attributes from methods that compute a scalar type value. A message of the form computeX( . . . ) or x:=computeX( . . . ):T, where T is a scalar type and computeX( . . . ) is a computation that produces a scalar type value, may suggest that X is an attribute of the object that receives the message. The type of the attribute is T.
5. Identify attributes from the parameters to a constructor. Most often, the scalar type parameters that are passed to a constructor are used to initialize the newly created objects of a class.
Attributes are also identified from the domain model. For each class of the DCD, examine the corresponding class in the domain model and identify attributes that are needed by the operations of the DCD class. The identified attributes are entered into the DCD.

Step 4—Identifying Relationships Between Classes. The inheritance, aggregation and association relationships are presented in the domain modeling. These relationships are conceptualization relationships. They exist in the application domain, or are introduced by design. In addition to these, there are several UML defined stereotyped relationships including instantiation, call, and use. These relationships are the result of design decisions. The instantiation relationship signifies that an object of a class creates an object of another class. It is also referred to as the create relationship. The call relationship specifies the fact that an object of a class invokes a method of an object of another class. The use relationship indicates that an object of a class depends on an object of another class, e.g., the former receives the latter as a return value from a function call, or the former receives a message with the latter passed as a parameter. This means that the call relationship implies the use relationship. These mean that once a create relationship between two classes exists, then there is no need to identify call and use relationships between the two classes. Similarly, if a call relationship between two classes exists, then it is no need to add a use relationship.

Relationships between the classes imply dependencies between the classes. Relationships between the classes are identified from the design sequence diagrams produced in the current iteration and the domain model by applying the following rules:
1. Identify create relationships from calls to constructors. If an object of class A invokes a constructor of class B, then A creates B.
2. Identify use relationships from classes as parameters or return types. That is, class A uses class B if one of the following holds:
   a. An object of class A passes an object of class B as a parameter in a function call. That is, A uses B in a function call.
   b. An object of class A receives an object of class B as a return value. That is, A receives the B object because it intends to use it.
   c. Class B is a parameter type of a function of class A. That is, a B object is passed to a function of class A because the function needs to use the B object.
   d. Class B is the return type of a function of class A. In this case, A uses B as a return type. At least, A needs to create or obtain an instance of B and returns it.
3. Identify association relationships from calls to constructors that pass two objects as parameters. If an object of class B and an object of class C are used as parameters to invoke a constructor of class A, then it is likely that an association relationship exists between class B and class C with A as the association class.
4. Identify aggregation relationships from calls to constructors that pass one or more objects as parameters. If objects of classes C1, C2, . . . , Ck, where k≧1, are passed as parameters to call a constructor of class A, then it is likely that A is an aggregation of C1, C2, . . . , Ck. This is because in object-oriented programming, component objects are often passed as parameters to a constructor of an aggregate class to construct an instance of the aggregate class.
5. Identify relationships from get object and set object messages. If getB( . . . ):B or setB(b:B) is a message to an object of class A, and A and B are a user-defined classes, then:
   a. A is an aggregation of B if an object of B is a part of an object of A.
   b. A uses B, as explained in Item 2 above.
   c. A associates with B if A and B are not aggregates of, or used by each other.
6. Identify call relationships. If an object of class A calls a method of class B, then A calls B.
7. Identify containment relationship from messages to add, get, or remove objects. A containment relationship between class A and class B, i.e., A contains B, is identified if an object of class A receives messages of the form: add(b: B), get( . . . ): B, getB( . . . ):B, or remove(b: B), where A and B are user defined classes.
8. Identify additional relationships from the domain model. Inheritance, aggregation and association relationships, and possibly additional classes, are identified from the domain model.

Step 5—Design Class Diagram Review Checklist. To ensure quality, the DCD should be reviewed by the team members using the following review checklist:
1. Check that the classes, attributes, operations, parameter types, return types and relationships in the DCD are derived correctly according to the steps presented.
2. Does the DCD contain unnecessary classes, operations, or relationships?
3. Does the naming of the classes, attributes, operations and parameters communicate concisely the intended functionality and is easy to understand?
4. Does the DCD clearly indicate the design patterns used? (This often helps the programmer in the implementation phase)

Organize Classes. The DCD may contain numerous classes, making it difficult to understand. In this case, UML package diagram may be useful for organizing the classes into logical partitions called packages. The packages may be organized in different ways (e.g. Functional subsystem organization, Architectural style organization, and Hybrid organization).

Functional subsystem organization—The functional subsystem organization partitions the classes according to the functional subsystems of the software system.

Architectural style organization—The architectural style organization groups the classes according to the architectural style of the system.

Hybrid organization—The hybrid approach combines the architectural style organization and the functional subsystem organization. It can apply one of the following two approaches:
1. Architectural style functional subsystem organization. In this approach, the classes in each of the architectural packages are organized according to the functional subsystems of the system.
2. Functional subsystem architectural style organization. In this approach, the classes in each functional package are organized according to the architecture of the system.

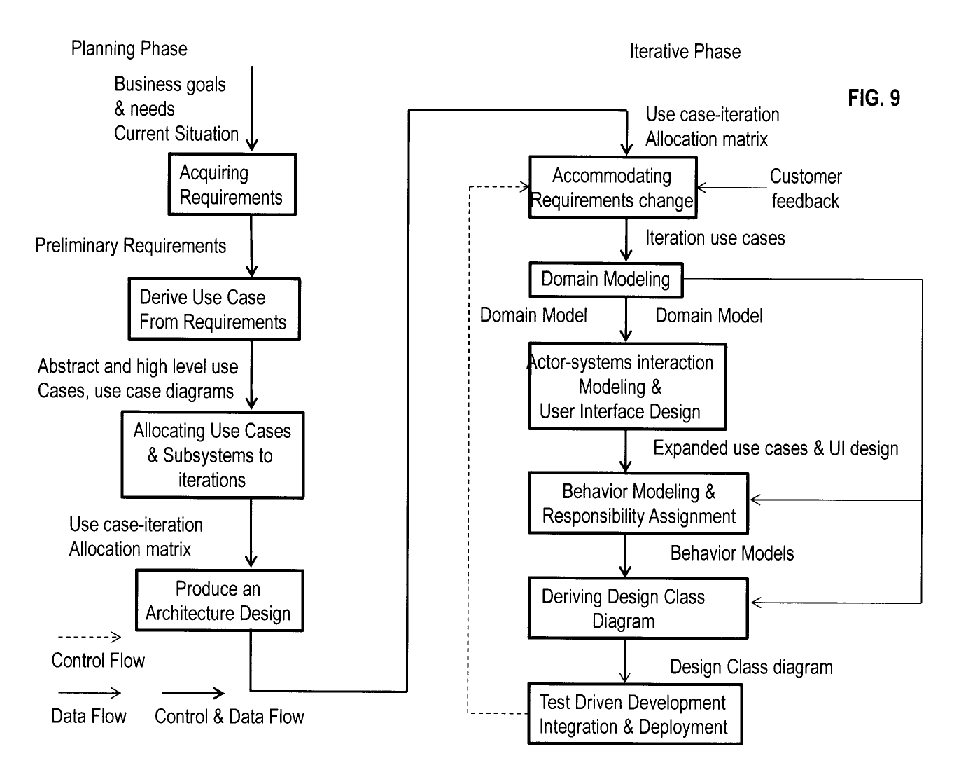

The invention preferably resides as software on a computer, but could also reside on a server or multiple servers, or be implemented in hardware or the like. In a preferred embodiment as illustrated in FIG. 9, the system receives requirement data. Once the information is retrieved, the system analyzes the information based on use case rules. Based on these rules, the system converts the requirements into use cases and then converts the use cases into a graphical representation of the use cases. The system further provides the ability to generate a domain model which is constructed or extended to facilitate understanding of a portion of the application domain that is related to the use cases allocated to the current iteration. The domain model is visualized using a UML class diagram. During the actor-system interaction modeling phase, expanded use cases for the current iteration are produced. These specify how the actors will interact with the system to carry out the use cases. The domain model provides the information needed to specify the actor input and system responses about domain objects. In the User interface design step, the windows and dialogs, for the actors to interact with the system, as well as their look-and-feel are designed and specified. The expanded use cases produced during actor-system interaction modeling provide the information required by user interface design. In the OIM phase, the nontrivial steps of actor-system interaction are identified and sequence diagrams are produced to show how the software objects interact and collaborate to carry out these steps. In the design class diagram creation phases, a UML class diagram is derived from the behavioral models and the domain model. It provides a blueprint to facilitate implementation, testing and integration activities.

Thus it is seen that systems and methods are provided for automating application of a software methodology when designing and creating software from a requirement specification. Although particular embodiments have been disclosed herein in detail, this has been done for purposes of illustration only, and is not intended to be limiting with respect to the scope of the claims, which follow. In particular, it is contemplated by the inventor that various substitutions, alterations, and modifications may be made without departing from the spirit and scope of the invention as defined by the claims. Other aspects, advantages, and modifications are considered to be within the scope of the following claims. The claims presented are representative of the inventions disclosed herein. Other, unclaimed inventions are also contemplated. The inventors reserve the right to pursue such inventions in later claims.

Insofar as embodiments of the invention described above are implemented, at least in part, using a computer system, it will be appreciated that a computer program for implementing at least part of the described methods and/or the described systems is envisaged as an aspect of the invention. The computer system may be any suitable apparatus, system or device, electronic, optical, or a combination thereof. For example, the computer system may be a programmable data processing apparatus, a computer, a Digital Signal Processor, an optical computer or a microprocessor. The computer program may be embodied as source code and undergo compilation for implementation on a computer, or may be embodied as object code, for example.

It is also conceivable that some or all of the functionality ascribed to the computer program or computer system aforementioned may be implemented in hardware, for example by one or more application specific integrated circuits and/or optical elements. Suitably, the computer program can be stored on a carrier medium in computer usable form, which is also envisaged as an aspect of the invention. For example, the carrier medium may be solid-state memory, optical or magneto-optical memory such as a readable and/or writable disk for example a compact disk (CD) or a digital versatile disk (DVD), or magnetic memory such as disk or tape, and the computer system can utilize the program to configure it for operation. The computer program may also be supplied from a remote source embodied in a carrier medium such as an electronic signal, including a radio frequency carrier wave or an optical carrier wave.

It is accordingly intended that all matter contained in the above description or shown in the accompanying drawings be interpreted as illustrative rather than in a limiting sense. It is also to be understood that the following claims are intended to cover all of the generic and specific features of the invention as described herein, and all statements of the scope of the invention which, as a matter of language, might be said to fall there between.

Having described the invention, what is claimed as new and secured by Letters Patent is:

1. A method for converting user requirements into a software product which satisfies the requirements, the method comprising:
receiving as input to a software program at least one customer requirement, wherein said requirement includes at least a verb-noun phrase that indicates a task being accomplished for an actor who initiates the task, a noun or noun phrase that represents said actor and a noun or noun phrase that represents a system;
said software program parsing said requirement for said verb-noun phrase, said noun or noun phrase representing said actor and said noun or noun phrase representing said system;
said software program identifying said verb-noun phrase, said noun or noun phrase representing said actor and said noun or noun phrase representing said system as a use case; and,
said software program converting said use case into a graphical representation.

2. The method according to claim 1 wherein said at least one requirement includes a plurality of requirements and wherein said software program identifies a use case for each of said requirements, said method further comprising:
receiving as further input to the software program a business description document;
said software program parsing said business description document for phrases representative of corresponding domain-specific concepts for an object-oriented software application;
said software program receiving user input identifying a phrase among the selected phrases and identifying the phrase, and a predetermined list of characteristics, wherein different characteristics among the list of characteristics correspond to different object-oriented modeling concepts;
said software program selecting a characteristic for the identified phrase from the predetermined list of characteristics; and
classifying the selected phrase as pertaining to an object-oriented modeling concept that corresponds to the selected characteristic;
wherein the different object-oriented modeling concepts comprise at least three modeling concepts from the group consisting of classes, attributes, inheritance, aggregation, and association relationships.

3. The method according to claim 2 further comprising:
said software program converting said parsed information into a two-column actor-interaction table, wherein a first column identifies an input of an actor and another column identifies a system response to said actor input.

4. The method according to claim 3 further comprising:
said software program analyzing said another column for a system response which requires additional processing;
said software program creating a five column scenario table wherein said columns of said scenario table includes an object interaction statement number, subject, subject action, data or objects required by said subject action and an object acted upon; and,
said software program converting said scenario table into a sequence diagram.

5. The method according to claim 4 further comprising:
said software program converting information from at least said sequence diagram into a design case diagram.

6. The method according to claim 1 further comprising:
said software program receiving verification that said use cases are correct; and,
said software program receiving at least one user identified use case which was not identified by said software product.

7. The method according to claim 4 wherein said software program receives user input for populating said scenario table.

8. The method according to claim 3 further comprising:
said software program receiving a five column scenario table wherein said columns of said scenario table includes an object interaction statement number, subject, subject action, data or objects required by said subject action and an object acted upon; and,
said software program converting said scenario table into a sequence diagram.

9. The method according to claim 8 further comprising:
said software program converting information from at least said sequence diagram into a design case diagram.

10. A system for converting user requirements into a software product which satisfies the requirements, the method comprising:
a processor configured to receive at least one customer requirement, wherein said requirement includes at least a verb-noun phrase that indicates a task being accomplished for an actor who initiates the task, a noun or noun phrase that represents said actor and a noun or noun phrase that represents a system;
said processor further configured to parse said requirement for said verb-noun phrase, said noun or noun phrase representing said actor and said noun or noun phrase representing said system;
said processor further configured to identify said verb-noun phrase, said noun or noun phrase representing said actor and said noun or noun phrase representing said system as a use case; and,
said processor further configured to convert said use case into a graphical representation;
a storage device in communication with said processor, configured to store said use case; and,
a user interface in communication with said processor, configured to receive and display said at least one customer requirement, said use case and said graphical representation.

11. The system according to claim 10:
wherein said at least one requirement includes a plurality of requirements;
wherein said processor is configured to
identify a use case for one of said requirements,
receive as further input a business description document;
parse said business description document for phrases representative of corresponding domain-specific concepts for an object-oriented software application;
receive user input identifying a phrase among the selected phrases and identifying the phrase, and a predetermined list of characteristics, wherein different characteristics among the list of characteristics correspond to different object-oriented modeling concepts;
select a characteristic for the identified phrase from the predetermined list of characteristics; and
classify the selected phrase as pertaining to an object-oriented modeling concept that corresponds to the selected characteristic;
wherein the different object-oriented modeling concepts comprise at least three modeling concepts from the group consisting of classes, attributes, inheritance, aggregation, and association relationships.

12. The system according to claim 11 wherein said processor is further configured to:
convert said parsed information into a two-column actor-interaction table, wherein a first column identifies an input of an actor and another column identifies a system response to said actor input, and store said actor interaction table in said storage device.

13. The system according to claim 12 wherein said processor is further configured to:
analyze said another column for a system response which requires additional processing;
create a five column scenario table, wherein said columns of said scenario table include an object interaction statement number, subject, subject action, data or objects required by said subject action and an object acted upon; and
convert said scenario table into a sequence diagram;
said storage device further configured to store said scenario table; and,
said user interface further configured to display said scenario table.

14. The system according to claim 13 wherein said processor is further configured to convert information from at least said sequence diagram into a design case diagram and said user interface is further configured to display said design case diagram.

15. The system according to claim 11 wherein said processor is configured to identify a use case for a plurality of said requirements.

16. The system according to claim 12 further comprising:
said processor further configured to receive a five column scenario table wherein said columns of said scenario table include an object interaction statement number, subject, subject action, data or objects required by said subject action and an object acted upon; and,
said processor configured to convert said scenario table into a sequence diagram.

17. The system according to claim 16 further comprising:
said processor further configured to convert information from at least said sequence diagram into a design case diagram.

18. A method for converting user requirements into a software product which satisfies at least a majority of the requirements, the method comprising:
receiving as input to a software program a customer requirement, wherein said requirement includes at least a verb-noun phrase that indicates a task being accomplished for an actor who initiates the task, a noun or noun phrase that represents said actor and a noun or noun phrase that represents a system;
said software program receiving an identification of said verb-noun phrase, said noun or noun phrase representing said actor and said noun or noun phrase representing said system as a use case; and,
said software program converting said use case into a graphical representation.
